(19) United States
(12) Patent Application Publication
(10) Pub. No.: US 2008/0136945 A1
(43) Pub. Date: Jun. 12, 2008

(54) Apparatus and method for reducing dark current

(75) Inventors: Laurent Blanquart, Westlake Village, CA (US); Joey Shah, Thousand Oaks, CA (US)

Correspondence Address: REED SMITH, LLP, TWO EMBARCADERO CENTER, SUITE 2000, SAN FRANCISCO, CA, 94111, US

(73) Assignee: AltaSens, Inc.

(21) Appl. No.: 11/634,560

(22) Filed: Dec. 6, 2006

(51) Int. Cl. H04N 9/64

(52) U.S. Cl. 348/243; 348/E05.081

(57) ABSTRACT

An apparatus and method that reduces the dark current in each pixel of an image sensor, where each pixel has a pinned photodiode. A negative potential barrier at the transfer gate of each pixel is raised when the photodiode is integrating (when the transfer gate is “off”) to thereby eliminate dark current generation in this region. The potential barrier is applied via a “triple well” transistor circuit structure that is capable of handling a strongly negative voltage. The circuit structure also serves as a conduit for conducting a strongly positive voltage to minimize the potential barrier during signal transfer and readout, thereby reducing image lag.

### BACKGROUND OF THE INVENTION

1. Field of the Invention

The present invention relates generally to electronic imaging sensors, and more particularly, to an apparatus and method for reducing dark current.

2. Description of the Related Art

The two types of semiconductor-based imagers in widespread use today are charge coupled devices (CCD) and CMOS image sensors (CIS).

Commercial cameras have largely relied on CCD imagers for the last 20 years. The key CCD advantage enabling dominance until now is the ability to produce high quality images at video rates up to about 20 MHz at satisfactory cost. Although other drawbacks have been successively accommodated by camera designers, the key CCD disadvantage that has become a major technical barrier over the past 5 years and reinvigorated competition is excess white noise at video rates above 20 MHz. Specifically, the emergence of high resolution digital still cameras (DSC) and high definition television has exposed the fact that CCD output amplifier noise increases rapidly and is excessive at video rates above about 20 MHz. Thus, it is impractical to use CCDs for the latest imaging products requiring maximum performance. Cameras supporting high video rates at the highest possible performance consequently use CIS alternatives.

While CIS sensors have inherent performance advantages at high video rates, their best performance in visible light cameras has often been of lower quality (than the best CCD-based cameras operating at lower rates) due to the fact that the available CMOS processes were optimized for microprocessor and memory chips rather than high performance imaging sensors. However, this deficiency has largely been eliminated over the last two years, since deep submicron CMOS technology has now been retuned to optimally support high performance image formation. The outcome is that CMOS sensors now supply purer electrical signals than competing CCDs in the latest multi-megapixel cameras that produce composite video at 74.25 MHz for standard HDTV, about 100 MHz for DSLRs, and about 1 GHz for other uses.

Ongoing efforts to further mature CIS technology have improved low light performance in the imaging system-on-chip sensors (iSoC) by minimizing dark current. It is well known that photodiode dark current (i.e., current not caused by detected electromagnetic radiation) is primarily due to thermal generation of charge carriers either at the edges of the photodiode or at the interface between the silicon and SiO₂ for surface photodiodes. The former issue is fundamental to silicon due to mid-gap states. The latter source of dark current can be significantly reduced by a method alternately called “hole accumulation,” “inversion mode,” or “multi-phase pinning.” In all cases, the Si-SiO₂ interface is inverted by applying either an inverting bias or incorporating a dopant layer above the buried photodiode. The inversion layer isolates the buried photodiode junction and its depletion region from the Si-SiO₂ interface thereby reducing the total dark current by at least two orders of magnitude. An exemplary pinned photodiode was taught by Saks (IEEE EDL-1 No. 7 July 1980) for improving CCD performance. The innovation ultimately led to multi-pinned phase (MPP) CCDs with ultra-low dark current. Since MPP operation degrades dynamic range, the optional method of using a specific pinning implant became the superior solution.

Teranishi (IEDM 1982) hence embedded the buried n-type photodiode pocket under a p+surface implant to pin the Si-SiO₂ interface. Burkey (IEDM 1984) further refined the structure shown in FIG. 1 by adjusting the implant profiles to reduce image lag caused by the potential barrier located between the photodetector (PD) and the transfer gate (TG).

Whether implemented in CCD, CMOS or MOS technology, the pinned photodiode has continued to evolve by using new implantation technology, but still uses the same basic features including the p-type surface pinning layer, a buried collection junction to collect charges generated by radiation reaching the photodiode junction and the underlying semiconductor substrate, and a method for minimizing the potential barrier at the front edge of the transfer gate. The collection junctions have been either p-n or n-p junctions, depending on whether the substrate is of p-type or n-type conductivity, respectively.

An example of a more recent CCD embodiment is taught by Furumiya (IEDM 1994). Furumiya augments the basic structure by adding microlenses to focus the light onto the buried photojunction and by extending the collection volume deeper into the substrate by adding an n-extension to the bottom of the n-type photodiode as shown in FIG. 2.

Current CMOS active pixels use identical pinned photodiode structure with overlying microlens and color filter, but often add circuitry in each pixel to amplify the charge collected during the integration period. CMOS pixels are hence often called active pixels because they are usually equipped with such circuits to support pixel-based amplification and various sophisticated functions including digitization, filtering, high speed operation, or boosting signal-to-noise ratio at very low levels of illumination. However, a drawback of active pixel CMOS sensors is that when a significant part of the pixel surface is used for the support circuitry, the pixel's active collection area is reduced; this physical limitation mandates the inclusion of a microlens to focus the incident light into the smaller photodiode area.

Dierickx in U.S. Pat. No. 6,225,670 hence teaches a scheme to increase the effective fill factor in active pixel sensors by gathering the photogenerating signal under the photodiode and surrounding circuit elements. Unfortunately, the lateral collection region underlying the circuits does not uniformly absorb all wavelengths of light due to the absorption coefficient of silicon. Effective fill factor is hence, unfortunately, wavelength dependent and highly dependent on the temperature of the incident light.

Another example of a CMOS active pixel is embodied by Lee in U.S. Pat. No. 5,625,210. As shown in FIG. 3, Lee integrates an n-well CMOS pinned photodiode with a transfer gate into each active pixel element. The p-type substrate 24 forms a p-n photodiode with the n-region 22 which becomes the photoactive element and stores the collected photoelectrons. “Burying” the n-region 22 under p+ pinning region 20 confines the collected photoelectrons in the deeper n-region. Because the photodiode junction is prevented from touching the Si-SiO₂ interface 30, dark current is suppressed as earlier taught by Saks and Teranishi. The electrostatic potential created by pinning dopant region 20 also suppresses influence of oxide layer charge on junction potential.

The pinning dopant region 20 of the photodiode also reduces the capacitance of the collection junction and any associated kTC noise. The kTC noise of the sensor is set by this capacitance unless pixel reset is preferably performed by enacting full charge transfer from the photodiode through the TX gate to sense diffusion 26. Sense diffusion 26 must also be reset in this manner after it is read or its kTC noise will dominate.

The pinning dopant layer 20 also raises the minimum of the electrostatic potential well in which the photoelectrons are confined. When this potential well is shallower than the transfer bias of the transfer gate 28, the photodiode can be completely depleted or reset in a shorter amount of time. In this manner, all of the photoelectrons can be transferred by fully turning on the transfer gate 28. By transferring all the charge, there is also no signal left behind in the potential well to contribute to a later frame's image and generate lag.

An NMOS transistor is formed by the transfer gate 28 above the p-type substrate 24 between the buried charge collection n-well 22 and the floating diffusion 26. Application of a sufficient voltage to the transfer gate 28 forms a depletion region between the two n-wells 22 and 26, thereby creating an enhanced n-channel for transferring charge between the pinned photodiode and the floating diffusion 26. The primary function of the transfer gate 28 is hence to facilitate noise-free charge transfer between the buried photodiode and the sense diffusion. A secondary function is to prevent excess photo-signal from spilling over to diffusion 26.

While pixel noise and blooming can be so minimized, the use of pinned photodiodes in CMOS active pixels has, on the other hand, revived a CCD disadvantage. Because the actual photodiode is buried beneath the surface to minimize the dark current to a level limited by bulk rather than surface properties, there is a need to use higher operating voltages than nominally supported by the specific CMOS technology to fully maximize the photodetector's dynamic range. This concern is shown in FIG. 4 (Burkey et al., IEDM 1984), a plan cross-section of a typical pinned photodiode structure and the associated electrostatic potential. The Transfer Gate edge creates a potential barrier that impedes the full transfer of charge from the photodiode to the sense diffusion. Minimizing this barrier minimizes pixel noise and image lag, as previously attempted by Teranishi, Burkey, etc. Consequently, the recurring solution in both CCD and CMOS sensor cameras is to boost the transfer voltage to a sufficiently high level to lower the barrier.

As discussed to this point, the problem of fully transferring the charge from each pixel to minimize noise and image lag has often been addressed in the prior art. On the other hand, dark current suppression has not been adequately addressed, especially in CMOS active pixel sensors. Recently, to simultaneously achieve both objectives, Inoue (ED Vol. 50, No. 1 January 2003) teaches further optimizing the doping profile (especially in the region of the transfer gate) to minimize both image lag and excess dark current at low operating voltage compatible CMOS APS production. Nevertheless, the Inoue scheme still results in compromises that degrade saturation voltage and fixed pattern noise.

### SUMMARY OF THE INVENTION

In general, the present invention is an apparatus, method and image sensor that reduces the dark current in each pixel. More particularly, in one embodiment of the present invention, the negative potential barrier at the transfer gate of each pixel in an image sensor is raised when the photodetector is integrating (when the transfer gate is “off”) to thereby eliminate dark current generation in this region. The potential barrier is applied via a circuit structure that is capable of handling a strongly negative voltage. The circuit structure also serves as a conduit for conducting a strongly positive voltage to minimize the potential barrier during signal transfer and readout.

In one embodiment, a plurality of pixels connected via a bus to a transfer driver gate transistor. Each pixel comprises a pinned photodiode. The transfer driver gate transistor is constructed as a “triple well.” That is, a body p-type well is isolated from the image sensor p-type substrate by an n-type well. (As is known in the art, the polarity of the wells may be reversed to form an n-p-n triple well, depending on the polarity of the device). This isolation allows a strong negative voltage (or strong positive voltage) to be applied to each transfer gate in a row (or column) of pixels. The negative voltage is set to a value sufficient to pull positive charge to the surface of the pixel in order to electrically passivate defect sites located at the surface under the transfer gate and thereby reduce the total dark current generated by the photodiode.

Additionally, the voltage at each transfer gate may be set to a strong positive voltage during charge transfer to reduce image lag.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a prior art pinned-diode photodetector assembled on a p-type semiconductor substrate for CCD application;

FIG. 2(a) illustrates a prior art pinned-diode photodetector assembled on a p-type semiconductor substrate for CCD applications, including microlenses and n-extensions;

FIG. 2(b) illustrates a prior art pinned-diode photodetector assembled on a p-type semiconductor substrate for CCD applications, including only microlenses;

FIG. 3 illustrates a prior art pinned-diode photodetector assembled on a p-type semiconductor substrate for CIS application;

FIG. 4 illustrates a prior art pinned-diode photodetector assembled on a p-type semiconductor substrate for CCD application along with a cross-section plan of the electrostatic potential;

FIG. 5 illustrates the potential issue of forward-biasing the parasitic diodes of a conventional NMOS transistor when negative voltage is applied to the transistor source or drain;

FIG. 6 illustrates one embodiment of the present invention wherein the NMOS transistor is situated in a triple well to handle strongly negative voltages in an imaging sensor; and

FIG. 7 illustrates the present invention, showing an image sensor using the triple well of FIG. 6 in an image sensor having pinned photodiodes.

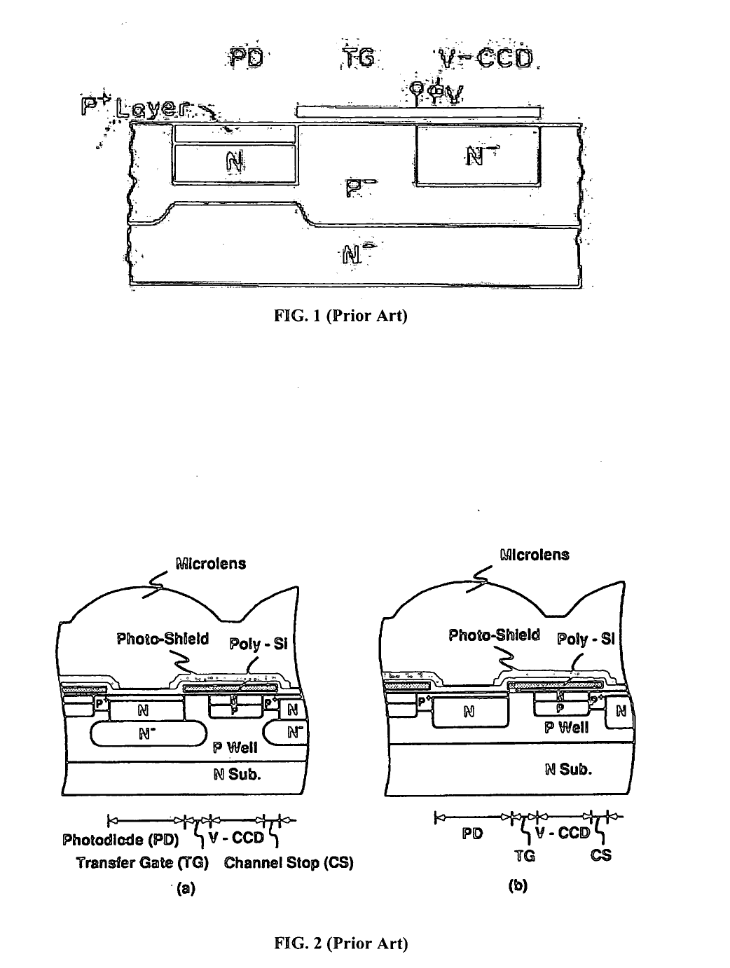

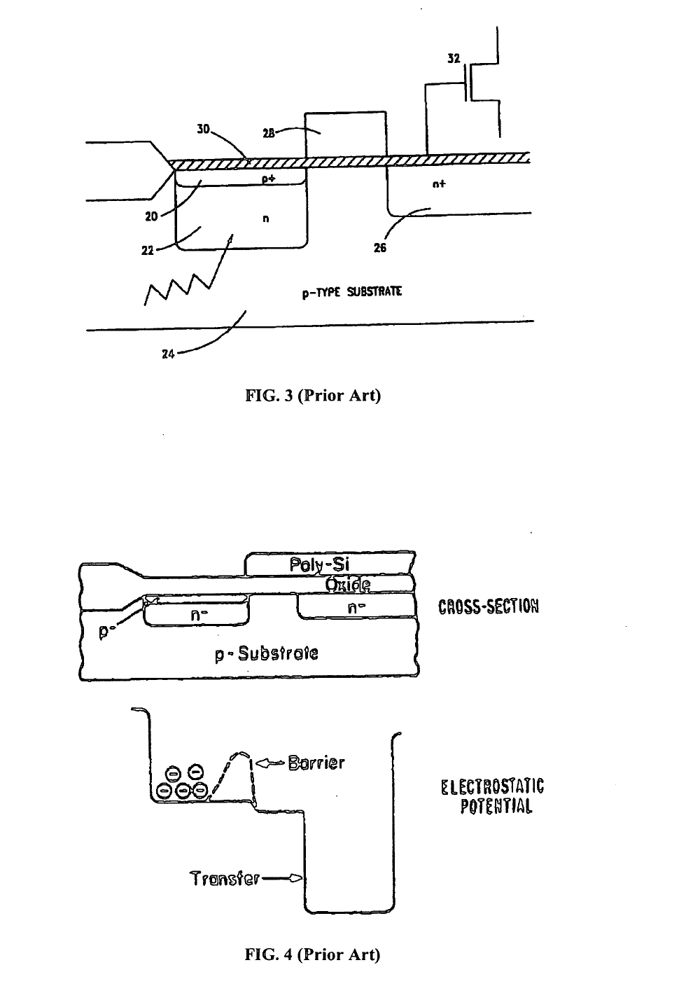

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

The present invention provides a system-on-chip solution that overcomes the disadvantages of the devices described in the prior art while maintaining or enhancing their favorable characteristics. The present invention is applicable to any active or passive pixel structures.

In pinned photodiode pixels, a large portion of the dark current is actually generated in the region near the transfer gate. The transfer gate is an electrically programmable barrier between the pinned photodiode and the floating diffusion which converts the photo-generated charge into an electrical voltage proportional to each pixel's signal. Some reasons for excess dark current generation include the following:
The photodiode implant must be close to the surface in this region so that charge can be transferred to the floating diffusion via the transfer gate without lag. Incorrect placement increases the probability that surface defects will increase dark current or that image lag will become excessive.
The electric fields in this region are higher since the floating diffusion is often at a voltage that is near the supply level (e.g. 3.3 volts). The higher electric field increases photodetector dark current.

According to the present invention, the transfer gate for each row of pixels in an image sensor is set to a strongly positive voltage during charge transfer to eliminate image lag. This active approach minimizes issues arising from production variations in the optimum profiles of the special dopant implants.

Also, the transfer gate of each pixel is set to a strongly negative voltage; sufficiently negative that when the gate is turned off to pull holes (positive charge) to the surface, these holes electrically passivate defect sites located at the surface under the transfer gate and thereby reduce the total dark current generated/collected by the photodiode. Similarly, this technique eliminates issues arising from production variations in the optimum profiles of the special dopant implants.

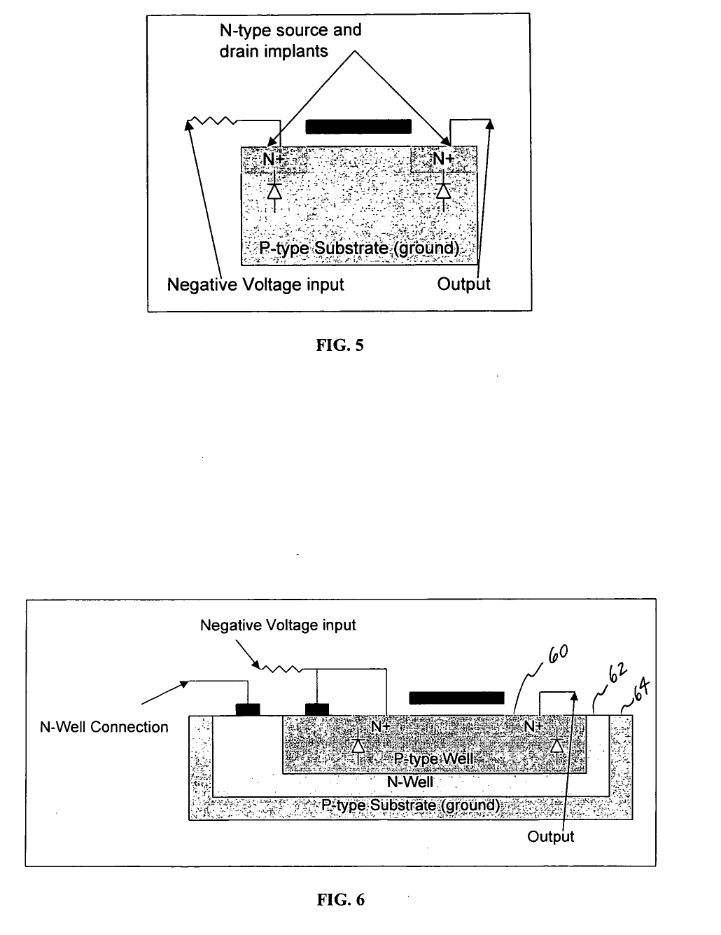

In conventional CMOS image sensor technology, the lowest possible voltage is about −0.7 volts. This is because at some point in the signal chain, the negative voltage needs to be switched “on” to a row in the pixel array via an NMOS transistor transfer driver gate. In the standard CMOS process, the NMOS transistor is formed in the substrate (or epitaxial layer) which is typically held at ground. This results in creation of a parasitic diode between the source and drain of the NMOS and the substrate (see FIG. 5). If the voltage on either the source or drain is brought to a voltage sufficiently negative to turn on (forward bias) the parasitic diode to the substrate, large currents will flow from the substrate. This conduction path prevents the output voltage from going any lower due to large IR voltage drops in the wiring, contacts, transistors, etc.

Therefore, in order to overcome the limitation in the conventional art, according to the present invention the NMOS transfer driver gate transistors are contained within a triple well enclosure as shown in FIG. 6. The use of a triple well enclosure in standard CMOS technology allows setting the Transfer Gates of the pinned photodiodes in each pixel to a much stronger off-level to further reduce dark current. The actual voltage is, furthermore, programmable, to additionally compensate for variations occurring in production. The range of the negative voltage level is programmable from approximately 0V to −2V and the positive level is from approximately 3V to 5V.

An example of a transfer gate construction according to the present invention is shown in FIG. 6. The triple well transistor has its body 60 separated from the substrate 64 so that the body voltage does not have to be at ground. This enables using a strongly negative voltage without forward biasing the parasitic diode between the drain (source) and the transistor body since the P-Well 60 is connected to the source of the device. Since the negative voltage input will hence always be the lowest voltage in the system, this insures that the parasitic diode between source (drain) and the P-Well 60 will never be turned on. In a preferred embodiment, the negative voltage is set to approximately −2 volts. Generally, the negative voltage should be set to a value sufficient to effectively reduce the dark current in each pixel.

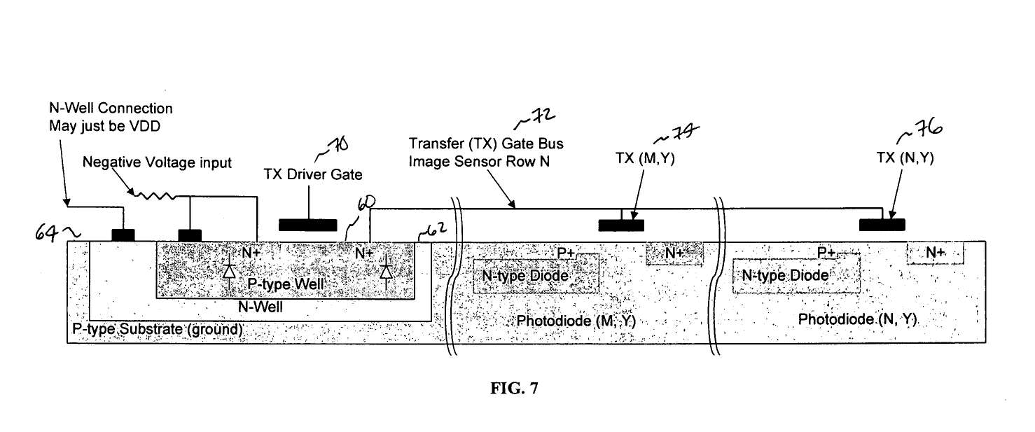

FIG. 7 illustrates a cross-sectional plan along a horizontal direction of an imaging sensor, which includes circuits on the periphery and utilizes pinned photodiode pixels. The image sensor comprises a plurality of pixels arranged in a plurality of rows. Each row has a transfer driver gate transistor 70 connected to the pixels via a bus 72. Note that the triple well isolates the row transfer driver gate 70 from the substrate 64 that is common to each pixel. Using the triple well transistors in the design of an image sensor thus enables lowering the off-level voltage on the transfer gates 74, 76 (or any other gate with a terminal connected to the pinned photodiode) to a value lower than −0.7 volts, such as −2 volts. Applying this strongly negative voltage to the transfer gates 74, 76 during signal integration greatly decreases the dark current in pinned photodiode-based CMOS image sensors.

In order to reduce image lag, the transfer gates 74, 76 may be set to a strong positive voltage during charge transfer. In a preferred embodiment, this strong positive voltage is approximately +5 volts.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An apparatus for reducing dark current in an image sensor, the apparatus comprising:
a plurality of pixels connected via a bus, each pixel comprising a pinned photodiode;
a driver transfer gate transistor formed as a triple well to isolate a transistor body from a sensor substrate, the driver transfer gate transistor connected to a plurality of pixel transfer gates via the bus; and
a negative voltage input connected between an input of the driver transfer gate transistor and the transistor body;
wherein a strong negative voltage is applied to the pixel transfer gates I of the plurality of pixels on the bus via the driver transfer gate, thereby reducing dark current in each pixel.

2. The apparatus of claim 1, wherein the transistor body is formed as a p-type well, and an n-type well isolates the p-type well from the p-type substrate.

3. The apparatus of claim 1, wherein the strong negative voltage is approximately −2 volts.

4. The apparatus of claim 1, wherein the transfer gates of each pixel is set to a strong positive voltage during charge transfer to reduce image lag.

5. The apparatus of claim 4, wherein the strong positive voltage is approximately +5 volts.

6. The apparatus of claim 1, wherein the negative voltage is set to a value sufficient to pull positive charge to the surface of the pixel in order to electrically passivate defect sites located at the surface under the transfer gate and thereby reduce the total dark current generated by the photodiode.

7. A method for reducing dark current in an image sensor having a plurality of pixels, the method comprising:
forming a driver transfer gate transistor as a triple well to isolate a transistor body from a sensor substrate;
connecting the driver transfer gate transistor to a plurality of pixel transfer gates in the image sensor via a bus;
applying a strong negative voltage to the pixel transfer gates on the bus via the driver transfer gate transistor when the pixel gates are in an off state in order to reduce dark currents; and
applying a strong positive voltage during charge transfer from the pixels to reduce image lag.

8. The method of claim 7, wherein the transistor body is formed as a p-type well, and an n-type well isolates the p-type well from the p-type substrate.

9. The method of claim 7, wherein the strong negative voltage is on the order of −2 volts.

10. The method of claim 7, wherein the strong positive voltage is approximately +5 volts.

11. The method of claim 7, wherein the negative voltage is set to a value sufficient to pull positive charge to the surface of the pixel in order to electrically passivate defect sites located at the surface under the transfer gate and thereby reduce the total dark current generated by the photodiode.

12. An electronic image sensor comprising:
a plurality of pixels arranged in rows, each pixel comprising a pinned photodiode and a transfer gate;
a driver transfer gate transistor connected to each row of pixels via a bus, each driver gate transistor formed as a triple well to isolate a body of the transistor from an image sensor substrate; and
a negative voltage input connected to each driver transfer gate transistor;
wherein, during an off state, a strong negative voltage is applied to the pixel transfer gates of each pixel on a bus via the driver transfer gate, thereby reducing dark current in each pixel.

13. The image sensor of claim 12, wherein the transistor body is formed as a p-type well, and an n-type well isolates the p-type well from the p-type substrate.

14. The image sensor of claim 12, wherein the strong negative voltage is approximately −2 volts.

15. The image sensor of claim 12, wherein the transfer gates of each pixel is set to a strong positive voltage during charge transfer to reduce image lag.

16. The image sensor of claim 15, wherein the strong positive voltage is approximately +5 volts.

17. The image sensor of claim 12, wherein the negative voltage is set to a value sufficient to pull positive charge to the surface of the pixel in order to electrically passivate defect sites located at the surface under the transfer gate and thereby reduce the total dark current generated by the photodiode.
